(19) United States
(12) Patent Application Publication
(10) Pub. No.: US 2005/0273829 A1
(43) Pub. Date: Dec. 8, 2005

(54) Digital multimedia broadcasting receiver and channel display method using the same

(75) Inventor: Ui-taek Oh, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/142,884

(22) Filed: Jun. 2, 2005

(30) Foreign Application Priority Data
Jun. 4, 2004 (KR) 2004-0040881

(51) Int. Cl. H04N 7/173; G06F 13/00; H04N 5/445; H04N 7/16

(52) U.S. Cl. 725/100; 725/131; 725/139; 725/151

(57) ABSTRACT

A digital multimedia broadcasting (DMB) receiver and a channel display method using the same, and more particularly, a digital multimedia broadcasting (DMB) receiver that allows a user to easily identify channels of a broadcast signal including a plurality of programs for a carrier frequency, and a channel display method using the DMB receiver. The digital multimedia broadcasting (DMB) receiver includes a tuner that receives a broadcast signal including a plurality of programs for a predetermined carrier frequency, a demodulating unit that demodulates the received broadcast signal to obtain channel information and program information, and a control unit that displays programs for a carrier frequency in a hierarchical format using a predetermined interface.

### CROSS-REFERENCE TO RELATED APPLICATIONS

This application claims priority from Korean Patent Application No. 10-2004-0040881 filed on Jun. 4, 2004 in the Korean Intellectual Property Office, the disclosure of which is incorporated herein by reference in its entirety.

### BACKGROUND OF THE INVENTION

1. Field of the Invention

The present invention relates to a digital multimedia broadcasting (DMB) receiver and a channel display method using the same, and more particularly, to a digital multimedia broadcasting (DMB) receiver that allows a user to easily identify a plurality of channels of a broadcast signal including a plurality of programs for a predetermined carrier frequency, and a channel display method using the DMB receiver.

2. Description of the Related Art

Similar to digital audio broadcasting (DAB), digital multimedia broadcasting (DMB) provides a user with broadcasting services that supply a plurality of programs included in a single carrier frequency.

DMB services transmit broadcasting signals through a satellite transponder or a terrestrial repeater to enable users, who may be moving (e.g., walking or traveling in a vehicle), to view or listen to various multimedia broadcasting (e.g., video or audio) via multi-channels using portable or car-mounted receivers having omni-directional reception antennas.

In addition, DMB provides a mobile service differentiated from existing fixed reception radio broadcasting techniques. Therefore, L-band (1452-1492 MHz) or S-band (2310-2360 MHz/2535-2655 MHz) is utilized.

A DMB signal is received directly from a satellite in most terrestrial areas or by means of gap fillers in areas beyond line of sight (LOS) satellite coverage. DMB services include multi-channel audio broadcasting, and traffic, weather, and global positioning system (GPS) information.

In DMB, since a plurality of programs are included in a predetermined carrier frequency, the user may first select a carrier frequency and then select one of the plurality of programs having the selected carrier frequency.

Also, when the user searches for a program of interest, he or she needs to know which programs are included in the corresponding carrier frequency.

However, it is impossible for the user to memorize all programs belonging to so many carrier frequencies. Accordingly, it is necessary to easily identify every channel of a received broadcast signal.

Japanese published application No. 2000-216693 discloses a digital broadcasting receiver in which when a user requests service names to be displayed collectively, services including ensembles, which are currently being selected and received, are sorted by a service identification (ID), and service names are then expressed on a display device in order. However, in this digital broadcasting receiver, the service names corresponding to the service IDs are collectively displayed regardless of user preference, and it is difficult for the user to select a desired program.

### SUMMARY OF THE INVENTION

Accordingly, it is an aspect of the present invention to provide a digital multimedia broadcasting (DMB) receiver that displays a plurality of programs included in a predetermined carrier frequency, in a hierarchical format having channel information and program information, and a channel display method using the DMB receiver.

Additional aspects and/or advantages of the invention will be set forth in part in the description which follows and, in part, will be apparent from the description, or may be learned by practice of the invention.

The foregoing and/or other aspects of the present invention are achieved by providing a digital multimedia broadcasting (DMB) receiver including a tuner, a demodulating unit, and a control unit. The tuner receives a broadcast signal including a plurality of programs in a predetermined carrier frequency. The demodulating unit demodulates the received broadcast signal to obtain channel information and program information. The control unit displays programs for each carrier frequency in a hierarchical format using a predetermined interface.

It is another aspect of the present invention to provide a digital multimedia broadcasting (DMB) receiver including a tuner to receive a broadcast signal including a plurality of programs for a predetermined carrier frequency, a demodulating unit to demodulate the received broadcast signal to obtain channel information and program types, and a control unit to display programs for each program type in a hierarchical format using a predetermined interface.

It is another aspect of the present invention to provide a channel display method using a digital multimedia broadcasting receiver, the method including receiving a broadcast signal including a plurality of programs for a predetermined carrier frequency, demodulating the received broadcast signal to obtain channel information and program types, and displaying programs for a carrier frequency in a hierarchical format using a predetermined interface.

It is another aspect of the present invention to provide a channel display method using a digital multimedia broadcasting receiver, the method including receiving a broadcast signal including a plurality of programs in a predetermined carrier frequency, demodulating the received broadcast signal to obtain channel information and program types, and displaying programs for each program type in a hierarchical format using a predetermined interface.

### BRIEF DESCRIPTION OF THE DRAWINGS

These and/or other aspects and advantages of the present invention will become more apparent and more readily appreciated from the following description of the embodiments taken in conjunction with the accompanying drawings of which:

FIG. 1 is a block diagram of a digital multimedia broadcasting (DMB) receiver according to an embodiment of the present invention;

FIG. 2 illustrates a structure of a broadcast signal according to an embodiment of the present invention;

FIG. 3 is a flowchart illustrating a channel display method using a DMB receiver, according to an embodiment of the present invention;

FIG. 4 illustrates an interface using the method of FIG. 3;

FIG. 5 is a flowchart illustrating a channel display method using a DMB receiver according to another embodiment of the present invention;

FIG. 6 illustrates an interface using the method of FIG. 5; and

FIG. 7 is a flowchart illustrating a channel display method using the interface of FIG. 6

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

The present invention may, however, be embodied in many different forms and should not be construed as being limited to the embodiments set forth herein.

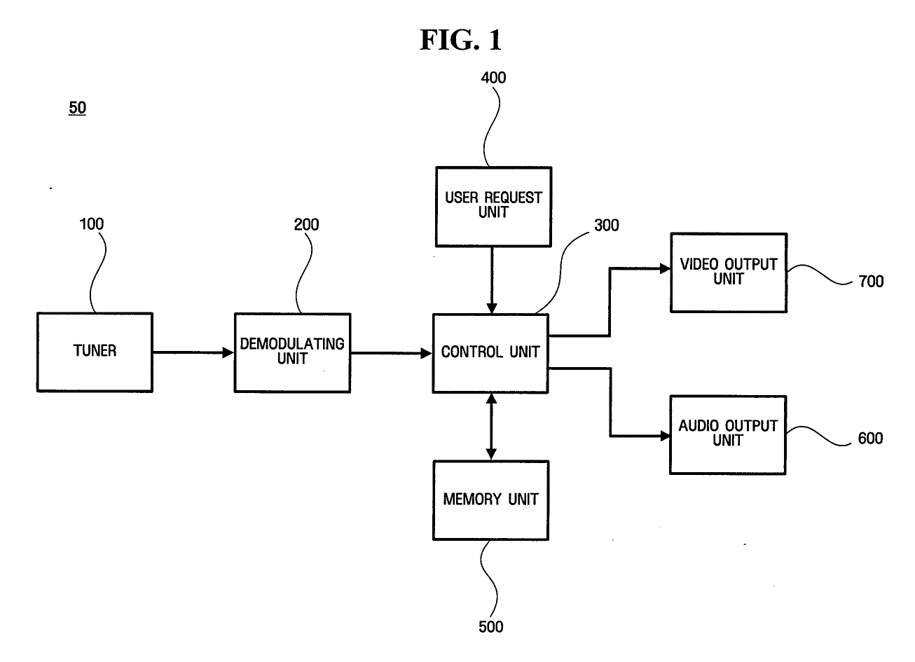

In FIG. 1, a digital multimedia broadcasting (DMB) receiver 50 according to an embodiment of the present invention, comprises a tuner 100 that receives a broadcast signal (not shown) including a plurality of programs for a predetermined carrier frequency, a demodulating unit 200 that demodulates the received broadcast signal to obtain channel information and program types, and a control unit 300 that uses a predetermined interface (not shown) to display programs for each carrier frequency in a hierarchical format having the obtain channel information and program types.

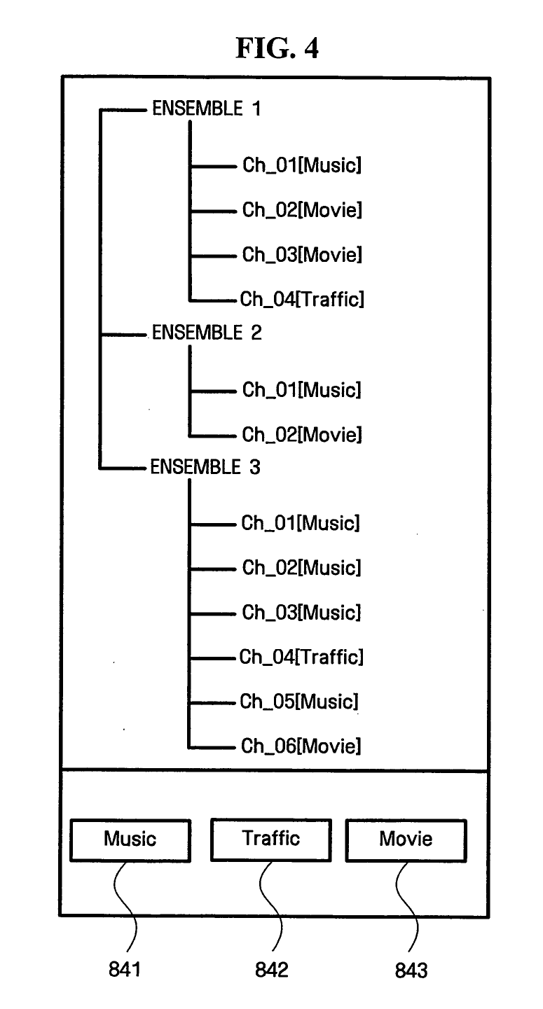

The DMB receiver 50 further comprises a user request unit 400 through which a user requests channel information and program types of the received broadcast signal, a memory unit 500 that stores an interface (see FIG. 4, for example) for displaying programs for each carrier frequency, and an audio output unit 600 and a video output unit 700 that output the broadcast signal that has been demodulated by the demodulating unit 200.

Here, the interface is displayed to the user through the video output unit 700.

Hereinafter, a carrier frequency will be referred to as an “ensemble”, and a plurality of programs for each carrier frequency will be referred to as “services”.

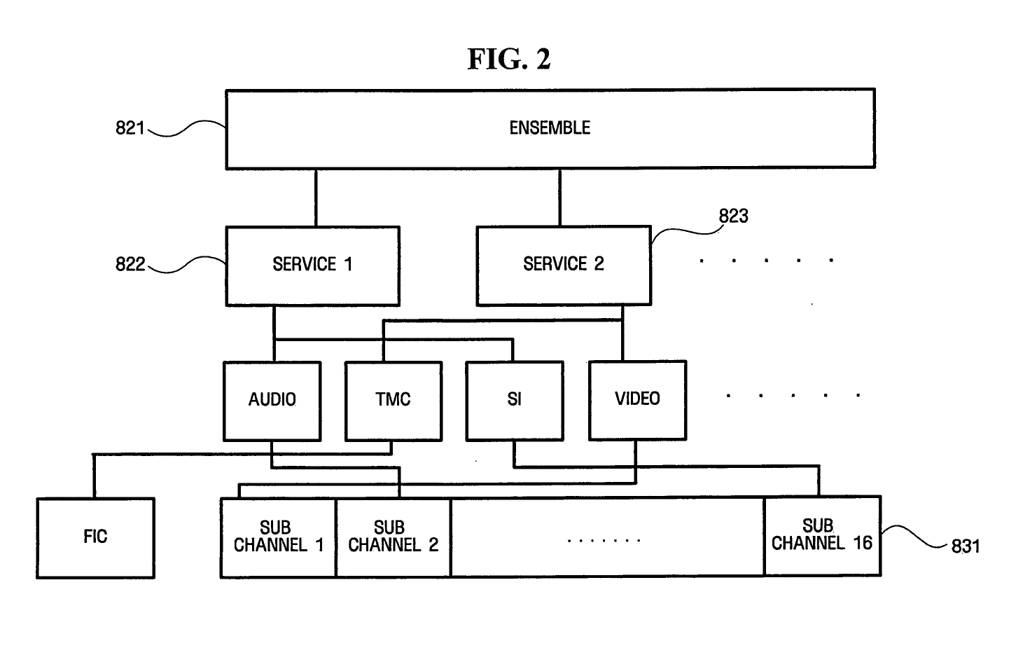

FIG. 2 illustrates a structure of a broadcast signal according to an embodiment of the present invention.

The broadcast signal received by the tuner 100 can be divided into main service components and sub service components.

The main service components include a video signal and an audio signal, and the sub service components include a traffic message channel (TMC) and service information (SI).

In DMB 50, the main service components and the sub service components can be transmitted via at least 16 sub channels 831.

Here, the main service components and the SI are transmitted via the sub channels 831, but the TMC is transmitted via a fast information data channel (FIDC) included in a separate fast information channel (FIC).

A plurality of services 822 and 823 included in an ensemble 821 may comprise of a single main service component and a single sub service component.

Referring to FIGS. 1 and 2, for example, the demodulating unit 200 obtains channel information of the ensemble 821 received by the tuner 100 and channel information and program types of the plurality of services 822 and 823 included in the received ensemble 821.

Here, the channel information of the ensemble 821 may be predefined or channels may be sequentially designated to frequency bands of the ensemble 821.

The control unit 300 displays the ensemble 821 and the plurality of services 822 and 823, in a hierarchical ensemble structure, through the predetermined interface.

The ensemble 821 and services 822 and 823 displayed through the predetermined interface comprise information on a plurality of channels and programs.

According to another embodiment of the present invention, the control unit 300 may display ensembles and services through the interface according to user-selected program information.

In other words, ensembles and services may be displayed in a hierarchical format for predetermined program information.

To this end, the control unit 300 allows the user to select predefined channel information and then displays services corresponding to this program information.

In addition to the user-selected program information, the control unit 300 may also display services in a hierarchical format with respect to default program information.

For example, when the user selects ‘Movie’ as program information, the control unit 300 displays services corresponding to this program information in a hierarchical format.

These ways of displaying services may be simultaneously used in some cases. For example, a plurality of services for each ensemble are displayed in a hierarchical format according to a user's request when a broadcast signal is first received, and then a plurality of services for each type of program information are then displayed in a hierarchical format according to user's selection.

A channel display method using a DMB receiver according to an embodiment of the present invention is as follows.

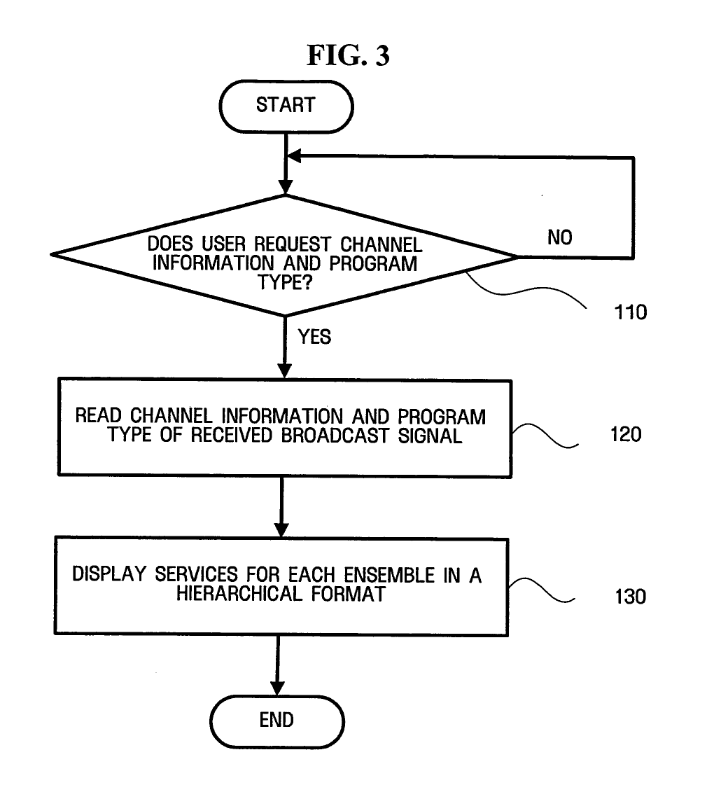

FIG. 3 is a flowchart illustrating a channel display method using a DMB receiver according to an embodiment of the present invention.

In operation 110, the control unit 300 determines whether a user requests channel information and program types of a received broadcast signal through the user request unit 400.

When the user requests the channel information and the program information in operation 110, the process moves to operation 120, where the demodulating unit 200 demodulates the broadcast signal received by the tuner 100 under the control of the control unit 300 to obtain the channel information and the program information of the received broadcast signal.

From operation 120, the process moves to operation 130, where the control unit 300 displays the channel information and program types for each ensemble in a hierarchical format through the interface.

As shown in FIG. 4, the interface may display a plurality of channels and program types.

For example, ensemble 1 of FIG. 4 comprises four channels: Ch_01, Ch_02, Ch_03, and Ch_04, and the program/service types: Music, Movie, Movie, and Traffic corresponding to these channels.

Here, the user may display services, in a hierarchical format according to program type, rather than according to ensembles, using program information buttons 841, 842, and 843 included in the interface.

Alternatively, the control unit 300 may display a plurality of services for program information, rather than each ensemble, in a hierarchical format at a user's request.

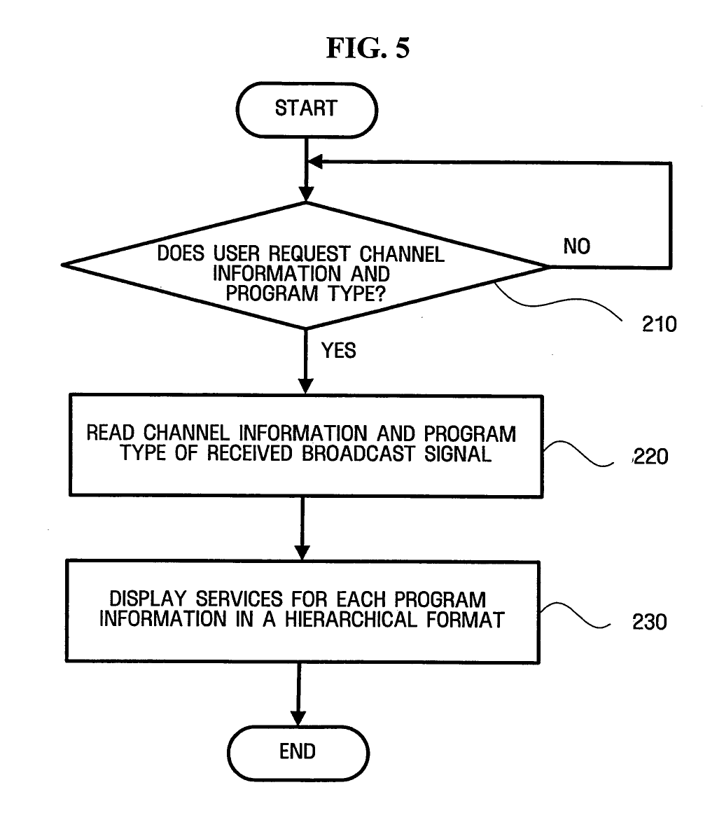

FIG. 5 is a flowchart illustrating a channel display method using a DMB receiver according to another embodiment of the present invention.

In operation 210, the control unit 300 determines whether a user requests channel information and program types of a received broadcast signal through the user request unit 400.

When the user requests the channel information and the program information in operation 210, the process moves to operation 220, where the demodulating unit 200 demodulates the broadcast signal received by the tuner 100 under the control of the control unit 300 to obtain the channel information and the program information.

The control unit 300 displays channels and program types in a hierarchical format through the interface.

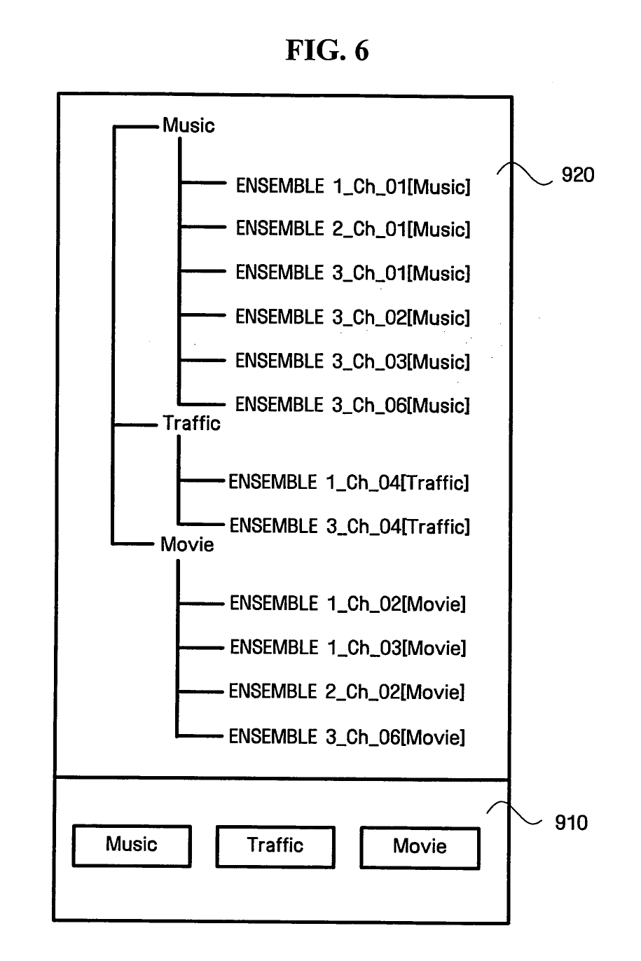

Here, as shown in FIG. 6, the interface may comprise a first portion 910 that allows the user to select a program type, and a second portion 920 where a plurality of services corresponding to the program type are displayed in a hierarchical format with respect to the selected program type.

In addition, the control unit 300 may display a plurality of services in a hierarchical format with respect to default program information.

The services displayed in the second portion 920 may comprise channel information and program types and channel information of ensembles.

For example, services corresponding to the program type ‘Music’ may be displayed as: ‘Ensemble number_Channel information[Program type]’; for example, ‘Ensemble1_Ch01 [Music]’, as shown in FIG. 6.

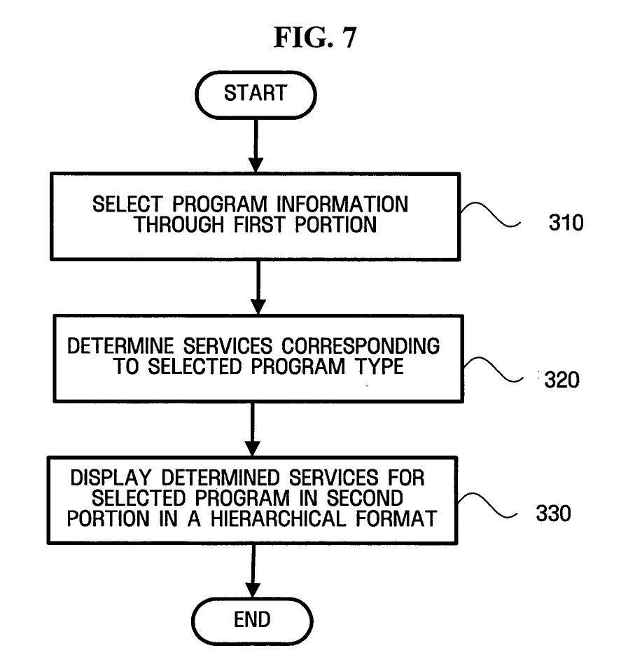

A channel display method for displaying services in a hierarchical format with respect to program type and using the interface of FIG. 6 will be described now with reference to FIG. 7.

In operation 310, a user selects a program type through the first portion 910.

From operation 310, the process moves to operation 320, where the control unit 300 determines services corresponding to the selected program type.

Here, the control unit 300 may obtain services corresponding to a default program type in addition to the user's selected program type.

From operation 320, the process moves to operation 330, where the determined services are displayed in a hierarchical format with respect to the selected program type using the channel information and program types of the determined services and the channel information of the ensembles.

As an alternative, the interfaces shown in FIGS. 4 and 6 may be simultaneously used in some cases.

For example, when the user displays a plurality of services corresponding to a program type selected using a program information button 841, 842, 843 in the interface of FIG. 4, the services may be displayed as shown in FIG. 6.

As described above, according to the present invention, since ensembles and services of broadcast signals are displayed in the form of hierarchical structures, a very user-friendly interface is created that allows users to recognize all channels at a glance.

Although a few embodiments of the present invention have been shown and described, it would be appreciated by those of skilled in the art that changes may be made in these embodiments without departing from the principles and spirit of the invention, the scope of which is defined in the claims and their equivalents.

1. A digital multimedia broadcasting receiver comprising:
a tuner to receive a broadcast signal including a plurality of programs for a predetermined carrier frequency;
a demodulating unit to demodulate the received broadcast signal to obtain channel information and program information; and
a control unit to display programs for a carrier frequency in a hierarchical format using a predetermined interface.

2. The digital multimedia broadcasting receiver of claim 1, wherein the predetermined interface comprises channel information and program information.

3. The digital multimedia broadcasting receiver of claim 2, wherein the control unit displays a plurality of programs corresponding to predetermined program information in a hierarchical format with respect to the predetermined program information.

4. The digital multimedia broadcasting receiver of claim 3, wherein the interface further comprises a plurality of program information buttons that allow a user to select the predetermined program information.

5. The digital multimedia broadcasting receiver of claim 4, wherein the plurality of programs corresponding to the predetermined program information selected by the user are displayed in a hierarchical format according to the user's selection when the broadcast signal is received.

6. A digital multimedia broadcasting receiver comprising:
a tuner to receive a broadcast signal including a plurality of programs for a predetermined carrier frequency;
a demodulating unit to demodulate the received broadcast signal to obtain channel information and program types; and
a control unit to display programs for each program type in a hierarchical format using a predetermined interface.

7. The digital multimedia broadcasting receiver of claim 6, wherein the predetermined interface comprises a first portion that allows a user to select predetermined program information and a second portion where programs corresponding to the predetermined program information selected by the user are displayed.

8. The digital multimedia broadcasting receiver of claim 7, wherein channel information and program information are displayed in the second portion.

9. A channel display method using a digital multimedia broadcasting receiver comprising:
receiving a broadcast signal including a plurality of programs for a predetermined carrier frequency;
demodulating the received broadcast signal to obtain channel information and program information; and
displaying programs for a carrier frequency in a hierarchical format using a predetermined interface.

10. The channel display method of claim 9, wherein the interface includes channel information and program information.

11. The channel display method of claim 10, further comprising displaying a plurality of programs for each program type in a hierarchical format.

12. The channel display method of claim 11, wherein the interface further comprises a plurality of program information buttons that allow a user to select program information.

13. A channel display method using a digital multimedia broadcasting receiver comprising:
receiving a broadcast signal including a plurality of programs for a predetermined carrier frequency;
demodulating the received broadcast signal to obtain channel information and program types; and
displaying programs for each program type in a hierarchical format using a predetermined interface.

14. The channel display method of claim 13, wherein the interface includes a first portion that allows a user to select predetermined program information and a second portion where programs corresponding to the predetermined program information are displayed.

15. The channel display method of claim 14, wherein channel information and program types are displayed in the second portion.
